(19) United States
(12) Patent Application Publication
(10) Pub. No.: US 2022/0037798 A1
(43) Pub. Date: Feb. 3, 2022

(54) LENS INTEGRATED PLANAR PROGRAMMABLE POLARIZED AND BEAMSTEERING ANTENNA ARRAY

(71) Applicant: Farrokh MOHAMADI, Irvine, CA (US)

(72) Inventor: Farrokh MOHAMADI, Irvine, CA (US)

(21) Appl. No.: 17/214,761

(22) Filed: Mar. 26, 2021

Related U.S. Application Data
(60) Provisional application No. 63/060,594, filed on Aug. 3, 2020.

(51) Int. Cl. H01Q 19/06; H01Q 7/00; H01Q 3/30

(52) U.S. Cl. CPC H01Q 19/062; H01Q 3/30; H01Q 7/00

(57) ABSTRACT

A lens integrated beamsteering antenna array with improved scan coverage is disclosed. The lens integrated beamsteering antenna array comprises a dielectric lens having a front surface and a back surface and an antenna array embedded within the dielectric lens proximate to the back surface of the dielectric lens. The antenna array is directed towards the front surface of the dielectric lens and is configured to transmit and receive through the dielectric lens and the front surface.

### CROSS-REFERENCE TO RELATED APPLICATIONS

This application claims the benefit of U.S. Provisional Application No. 63/060,594 filed Aug. 3, 2020, the contents of which are hereby incorporated by reference in their entirety.

### TECHNICAL FIELD

This application relates to antennas, and more particularly to an antenna array with a lens.

### BACKGROUND

With the growth of modern communications, there is a need for vehicular mounted on the move (OTM) antennas capable of simultaneous satellite communications with Low Earth Orbit (LEO) and Geosynchronous Earth Orbit (GEO) constellations. Several new markets are driving the need for small form factor and high data rate satellite access. Mobile platforms and dismounted soldiers would benefit from having access to these communication channels. Legacy Ka-band channels that used to be specific to airborne platforms are now being considered for wider access. This means that the mobile platforms that traditionally only needed to downlink a single Ka-channel may now need to operate on multiple channels with up-and-downlink capabilities.

However, current antennas have design challenges in meeting this need. Historically, parabolic dish antennas have been utilized for tactical satellite communication (SATCOM) systems because parabolic dish antennas offer a low-cost solution, with an antenna performance that meets requirements for effective isotropic radiated power (EIRP), receive gain/temperature (G/T), and size, weight, and power (SWaP). Unfortunately, these systems are limited in providing the multi-beam and multi-band solutions needed for an integrated LEO and GEO SATCOM capability. In addition to parabolic dish antennas, another type of antenna utilized for SATCOM applications is a phased array antenna. In general, a phased array antenna offers multi-beam and multi-band solutions but are often expensive and have limited field-of-regard (i.e., performance at low elevation angles) which is important for performance on tactical vehicles.

Therefore, there is a need for a new type of antenna system capable of addressing these issues.

### SUMMARY

A lens integrated beamsteering antenna array with improved scan coverage is disclosed. The lens integrated beamsteering antenna array comprises a dielectric lens having a front surface and a back surface and an antenna array embedded within the dielectric lens proximate to the back surface of the dielectric lens. The antenna array is directed towards the front surface of the dielectric lens and is configured to transmit and receive through the dielectric lens and the front surface at a first frequency, and the dielectric lens has a thickness that is configured to allow the antenna array to form an antenna beam within the dielectric lens at the first frequency.

In an example of operation, the lens integrated beamsteering antenna array performs a method that comprises producing an antenna beam with the antenna array that is directed towards a front surface of the dielectric lens, and deflecting the antenna beam away from an antenna boresight when the antenna beam emerges from the dielectric lens at the front surface.

Other devices, apparatuses, systems, methods, features, and advantages of the invention will be or will become apparent to one with skill in the art upon examination of the following figures and detailed description. It is intended that all such additional devices, apparatuses, systems, methods, features, and advantages be included within this description, be within the scope of the invention, and be protected by the accompanying claims.

### BRIEF DESCRIPTION OF THE DRAWINGS

The invention may be better understood by referring to the following figures. The components in the figures are not necessarily to scale, emphasis instead being placed upon illustrating the principles of the invention. In the figures, like reference numerals designate corresponding parts throughout the different views.

FIG. 1 is a system block diagram of an example of an implementation of a lens integrated beamsteering antenna array with improved scan coverage in accordance with the present disclosure.

FIG. 2 is a system block diagram of an example of another implementation of a lens integrated beamsteering antenna array with improved scan coverage in accordance with the present disclosure.

FIG. 3 is a system block diagram of an example of yet another implementation of a lens integrated beamsteering antenna array with improved scan coverage is shown in accordance with the present disclosure.

FIG. 4A is a system block diagram of an example of operation of the lens integrated beamsteering antenna array radiating in the boresight direction in accordance with the present disclosure.

FIG. 4B shows the lens integrated beamsteering antenna array radiating at a scan angle from the boresight direction in accordance with the present disclosure.

FIG. 5 is a system block diagram of an example of an implementation of two lens integrated beamsteering antenna arrays in accordance with the present disclosure.

FIG. 6 is a system block diagram of an example of an implementation of three lens integrated beamsteering antenna arrays in accordance with the present disclosure.

FIG. 7A is a cross-sectional view of a loop antenna having selective circular polarization in accordance with an aspect of the disclosure.

FIG. 7B is another cross-sectional view of the loop antenna 7A,

FIG. 8 is a perspective view of an antenna array in which each antenna is constructed as disclosed with regard to FIGS. 7A and 7E.

FIG. 9 is a plan view of the flexible dielectric selecting surrounding each circular loop in the antenna array of FIG. 8.

### DETAILED DESCRIPTION

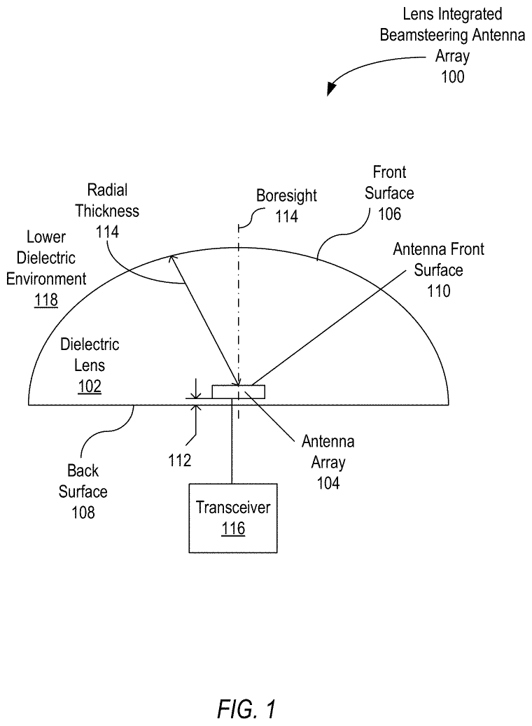

In FIG. 1, a system block diagram of an example of an implementation of a lens integrated beamsteering antenna array 100 with improved scan coverage is shown in in accordance with the present disclosure. In this example, the lens integrated beamsteering antenna array 100 comprises a dielectric lens 102 and an antenna array 104. The dielectric lens 102 includes a front surface 106 and a back surface 108; and the antenna array 104 is embedded within the dielectric lens 102 proximate to the back surface 108 of the dielectric lens 102. The antenna array 104 includes an antenna front surface 110 that is directed towards the front surface 106 of the dielectric lens 102 and is configured to transmit and receive through the dielectric lens 102 and the front surface 106 at one or more frequencies. In this example, the antenna array 104 is embedded within the dielectric lens 102 proximate to the back surface 108 of the dielectric lens 102 by either being adjacent to the back surface 108 of the dielectric lens 102 such that the antenna front surface 110 is physically in contact with the back surface 108 of the dielectric lens 102 or is physically integrated within the dielectric lens 102 up to a small distance 112 from the back surface 108 of the dielectric lens 102. In these examples, the dielectric material within the dielectric lens 102 is in physical contact with antenna front surface 110 such that there is no air gap between the array elements within antenna array 104 and the dielectric material of the dielectric lens 102.

In this example, the dielectric lens 102 has a radial thickness 114 (as measured from the antenna front surface 110) that is large enough to allow the antenna array 104 to form an antenna beam within the dielectric lens 102 at one or more frequencies of operation. In other words, the radial thickness 114 is large enough that the front surface 106 of the dielectric lens 102 is within the far-field of propagation of the antenna array 104 within the dielectric material of the dielectric lens 102 for the one or more frequencies of operation.

In an example of operation, the antenna array 104 includes a boresight 114 that is directed normal the antenna front surface 110 of the antenna array 104. The antenna array 104 may be electrically connected to a transceiver 116 for either transmitting or receiving signals with the antenna array 104. In an example of transmission, the transceiver 116 produces a signal that excites the antenna array 104 to produce an antenna beam along which the radiated energy from the antenna array 104 is transmitted. In this example, the antenna beam has a radiation pattern that is completely produced within the dielectric lens 102 before the radiated energy produced by the antenna array 104 reaches the front surface 106 of the dielectric lens 102 and propagates into the lower dielectric environment 118 outside of the front surface 106 of the dielectric lens 102. As an example, the lower dielectric environment 118 may be air in free space. In this example, the radial thickness 114 should be large enough so that the front surface 106 is within the far-field of lowest frequency (i.e., largest wavelength) of operation of the lens integrated beamsteering antenna array 100, where the far-field is a region of space that is at a large enough distance from the antenna front surface 110 such that the far-field radiation pattern of the antenna beam does not change shape as the distance from the antenna front surface 110 increases. It is appreciated by those of ordinary skill in the art that the far-field of an antenna is determined to be a distance defined as

far−field=approximately 10*λ

where λ is the wavelength of the radiated signal (i.e., the inversely proportional to the frequency of operation).

Once the antenna beam is produced within the dielectric material of the dielectric lens, the antenna beam has a first scan angle relative to boresight 114 (i.e., 0 degrees from the center of the antenna front surface 110). Once the radiated energy reaches the front surface 106 of the dielectric lens 102 along antenna beam at the first scan angle, the radiated energy hits the discontinuity of the different dielectric constants between the higher dielectric constant value of the dielectric material within the dielectric lens 102 to the lower dielectric constant value of the lower dielectric environment 118. In this example, the lower dielectric environment 118 may be air (approximately equal to 1) and the dielectric material of the dielectric lens 102 may be polytetrafluoroethylene (PTFE) having a dielectric constant of approximately 2.1.

This results in the radiated energy refracting when it reaches the discontinuity of dielectric constants at the front surface 106 producing a deflected antenna beam at the front surface 106 of the dielectric lens 102 that has a second scan angle relative to boresight 114 that is greater than the first scan angle because the second scan angle is a refracted angle produced by the radiated energy traveling from a higher dielectric material within the dielectric lens 102 to a lower dielectric material within the lower dielectric environment 118. In general, the relationship between first scan angle and second scan angle may be determined utilizing Snell's law where

$$\frac{sin {θ}_{2}}{sin {θ}_{1}} = \frac{{n}_{1}}{{n}_{2}} .$$

In this example, θ₁ represents the second scan angle relative to the boresight 114 in the lower dielectric environment 118, θ₂ represents the first scan angle relative to the boresight 114 in the dielectric material of the dielectric lens 102, n₁ represents the refractive index of the lower dielectric environment 118, and n₂ represents the refractive index of dielectric material within the dielectric lens 102. It is appreciated by those of ordinary skill that the dielectric constant is equal to the square of the refractive index such that if dielectric constants are known for both the dielectric material of the dielectric lens 102 and the lower dielectric environment 118, the second scan angle at the front surface 106 can be determined from the first scan angle within the dielectric lens 102.

In this example, the resulting antenna beam produced by the lens integrated beamsteering antenna array 100 has a greater directivity and lower side-lobes than an antenna beam produced by the antenna array 104 if operating in free space without the dielectric lens 102.

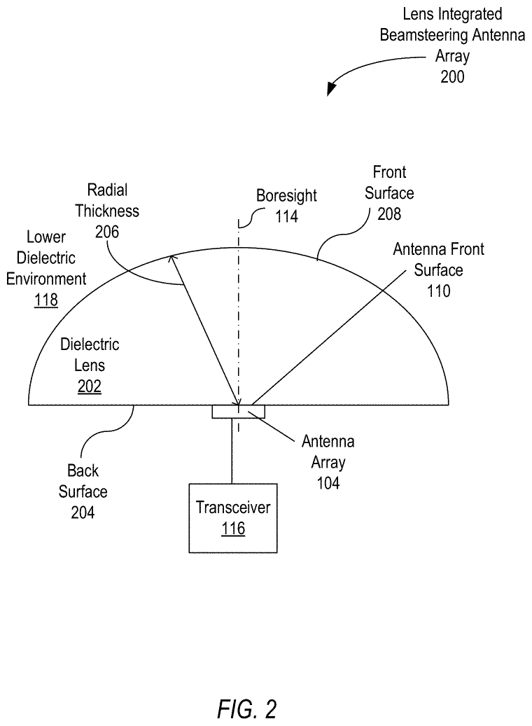

In this example, the dielectric lens 102 is shown as a hemispherical dielectric lens where the radial thickness 114 is equal to the radial distance from the antenna front surface 110 to the front surface 106. Also as discussed earlier, the antenna array 104 was shown as being physically within the dielectric material of the dielectric lens 102, turning to FIG. 2, an example of another implementation of the lens integrated beamsteering antenna array 200 is shown.

In this example, the lens integrated beamsteering antenna array 200 includes the antenna array 104 and a dielectric lens 202, however, the antenna array 104 is not within the dielectric lens 202 but is physically attached to the back surface 204 of the dielectric lens 202 where the antenna front surface 110 and back surface 204 of the dielectric lens 202 are physically attached without an air gap so an any radiation emitted from the antenna array 104 is radiated exclusively within the dielectric material of the dielectric lens 202. In this example, the radial thickness 206 is distance from the antenna front surface 110 to the front surface 208. Again, the dielectric lens 202 is designed such that the front surface 208 is in the far-field of the antenna array 104. Again, in this example, the dielectric lens 202 may be a hemispherical dielectric lens.

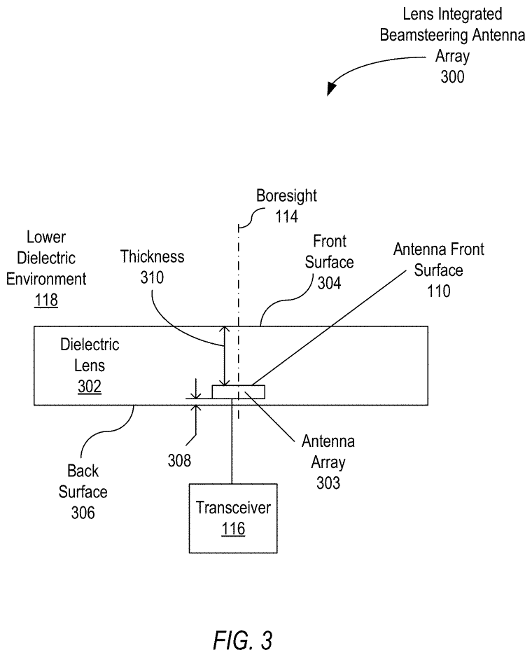

Turning to FIG. 3, a system block diagram of an example of yet another implementation of a lens integrated beamsteering antenna array 300 with improved scan coverage is shown in accordance with the present disclosure. In this example, the dielectric lens 302 is not hemispherical and may be rectangular such as a thick plate of dielectric material.

In this example, the lens integrated beamsteering antenna array 300 again comprises the dielectric lens 302 and an antenna array 303 where the dielectric lens 302 includes a front surface 304 and a back surface 306. The antenna array 303 is embedded within the dielectric lens 302 proximate to the back surface 306 of the dielectric lens 302. The antenna array 303 again includes the antenna front surface 110 that is directed towards the front surface 304 of the dielectric lens 302 and is configured to transmit and receive through the dielectric lens 302 and the front surface 304 at one or more frequencies. In this example, the antenna array 303 is embedded within the dielectric lens 102 proximate to the back surface 306 of the dielectric lens 302 by either being adjacent to the back surface 306 of the dielectric lens 302 such that the antenna front surface 110 is physically in contact with the back surface 306 of the dielectric lens 302 or is physically integrated within the dielectric lens 302 up to a small distance 308 from the back surface 306 of the dielectric lens 302. Again, in these examples, the dielectric material within the dielectric lens 302 is in physical contact with antenna front surface 110 such that there is no air gap between the array elements within antenna array 303 and the dielectric material of the dielectric lens 302.

In this example, the dielectric lens 302 has a thickness 310 (as measured from the antenna front surface 110) that is large enough to allow the antenna array 303 to form an antenna beam within the dielectric lens 302 at one or more frequencies of operation because the thickness 310 is large enough that the front surface 304 of the dielectric lens 302 is within the far-field of propagation of the antenna array 303.

In this example, it is noted spacing of the antenna elements in the antenna array 303 will be different than the spacing in the previous hemispherical example (i.e., antenna array 104) because in this example the spacing of the antenna elements 303 will generally not be a linear spacing so as to improve the beam forming of the radiation pattern of the antenna beam.

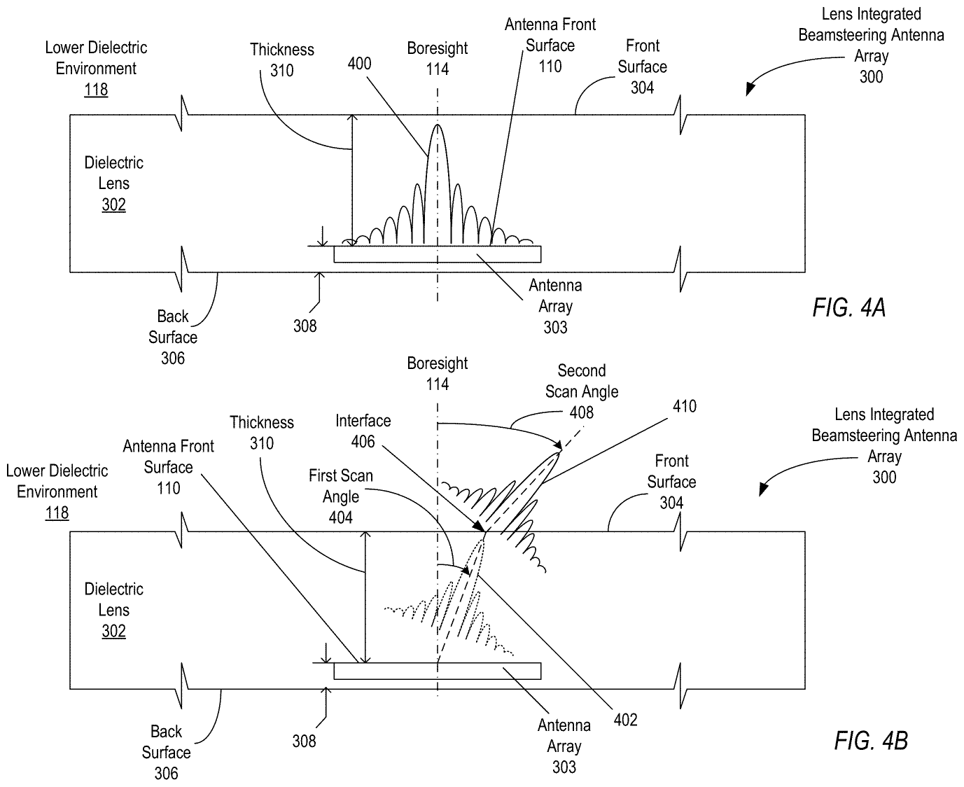

In FIG. 4A, a system block diagram is shown of an example of operation of the lens integrated beamsteering antenna array 300 radiating in the boresight 114 direction in accordance with the present disclosure. FIG. 4B shows the lens integrated beamsteering antenna array 300 radiating at a scan angle from the boresight 114 direction in accordance with the present disclosure. In this example, in FIG. 4A, a first radiation pattern 400 is shown being entirely within the width (i.e., thickness 310) of the dielectric lens 302, where the first radiation pattern 400 is directed in the boresight 114 direction. In FIG. 4B, a second radiation pattern 402 is shown being entirely within the thickness 310 of the dielectric lens 302, where the second radiation pattern 402 is directed at a first scan angle 404 from the boresight 114 direction. Once the radiated energy from the antenna array 104 reaches the front surface 304 of the dielectric lens 302 at the interface 406 point between the dielectric material of the dielectric lens 302 and the lower dielectric environment 118, the change in dielectric constant from the higher dielectric constant within the dielectric lens 302 to the lower dielectric constant within the lower dielectric environment 118 (i.e., air in free space) causes the radiated energy to be refracted such that the radiated energy will be directed at a second scan angle 408 when the radiated energy is emitted from the front surface 304 of the dielectric lens 302. The result is a shift in the radiated pattern of the antenna beam causing the antenna beam to have a new radiated pattern 410 produced by the dielectric lens 302.

It is appreciated by those of ordinary skill in the art that while these examples of operation are illustrated on a dielectric lens 302 that is rectangular, the same operation will happen with the curved dielectric lens such as, for example, the hemispherical dielectric lenses 102 and 202 discussed earlier. In those types of curved dielectric lenses, the deflection of the radiated energy will be along tangential interface points along the curved front surfaces of curved dielectric lenses and further enhances suppressing the sidelobes.

Utilizing these approaches, the lens integrated beamsteering antenna array 100, 200, and 300 widens the scanning window of the antenna array 104 or 303 by utilizing refraction to provide for extra angular scanning beyond what the antenna array 104 or 303 is capable of doing without degradation of the side-lobe levels within the second radiation pattern 402 produced by the antenna array 104. As an example, the antenna array 104 may be limited to scanning between ±23 degrees off boresight 114 without the use of the dielectric lens 302, while the lens integrated beamsteering antenna array 100, 200, and 300 may widen that scanning window to close to ±90 degrees with the proper selection of antenna array 104 or 303, frequency of operation, dielectric material for the dielectric lens 302, and the thickness 310. It is appreciated by those of ordinary skill in the art that multiple antenna beams may be produced by the lens integrated beamsteering antenna array 100, 200, and 300 in response to the antenna array 104 being excited at different frequencies of operation including X, Kᵤ, K, Kₐ, V, E, and higher band frequencies.

In this example, it is appreciated by those of ordinary skill in the art that flat dielectric lens 302 has been utilized for ease of illustration in how the second radiation pattern 402 is refracted into forming the new radiated pattern 410. However, in this example, the sidelobes of the new radiated pattern 410 may not be as effectively and uniformly suppressed during beamsteering as would be the case with the hemispherical dielectric lens 202 described previously in relation to FIGS. 1 and 2.

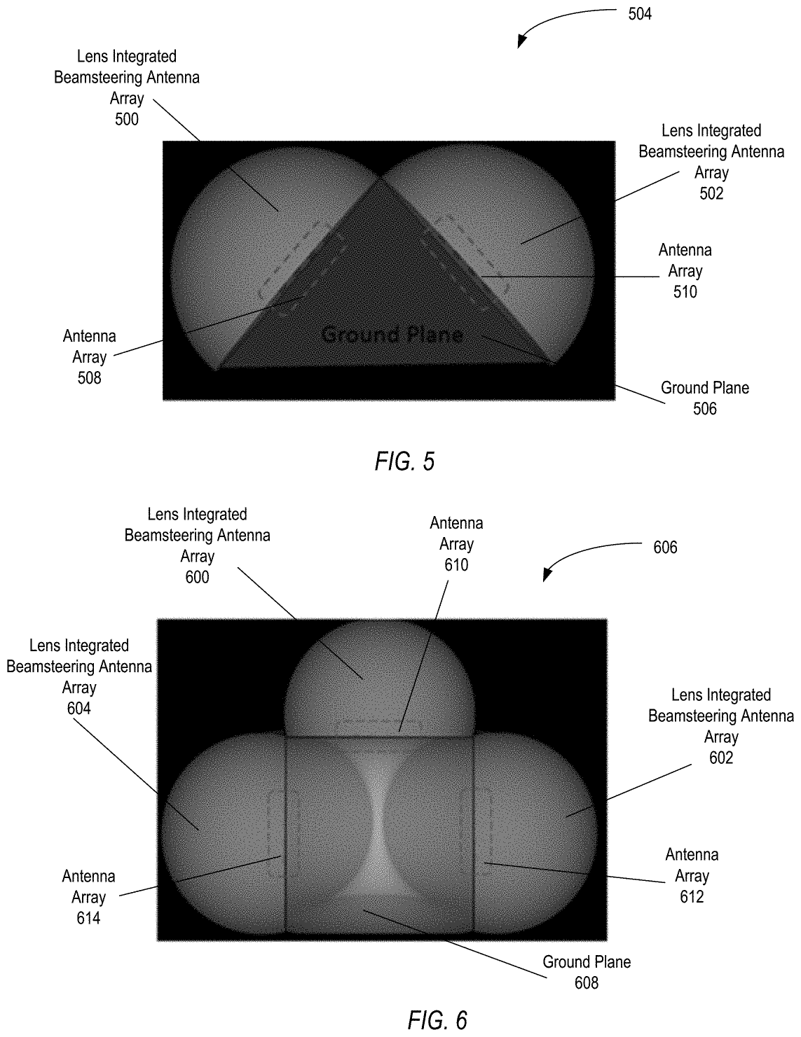

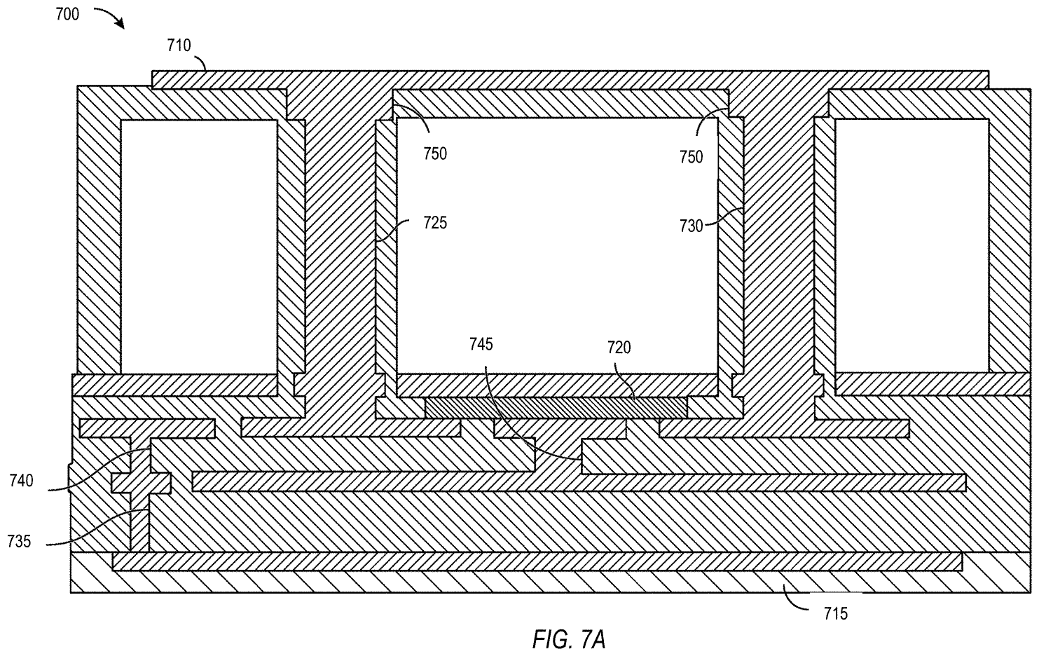

Turning to FIGS. 5 and 6, two different implementations of combined antennas utilizing multiple lens integrated beamsteering antenna array 100 or 200 are shown in accordance with the present disclosure. In FIG. 5, two lens integrated beamsteering antenna arrays 500 and 502 are shown integrated into a combined antenna 504. In this example, the lens integrated beamsteering antenna arrays 500 and 502 are placed on ground plane 506 at angles may be approximately 60 degrees from each other so as to produce a total scan coverage that is close to 270 degrees. In this example, each lens integrated beamsteering antenna array 500 and 502 has an antenna array 508 and 510 that is laid along the ground plane 506.

Turning to FIG. 6, three lens integrated beamsteering antenna arrays 600, 602, and 604 are shown integrated into another combined antenna 606 where there three are placed on a ground plane 608 at approximately 90 degrees from each other to provide a total scan coverage that is approximately 360 degrees. In this example, each lens integrated beamsteering antenna array 600, 602, and 604 has an antenna array 610, 612, and 614 that is laid along the ground plane 608.

In general, in this disclosure the antenna array 104 may include numerous antenna elements that may be configured to at different frequencies of operation and either right-hand circular polarization or left-hand circular polarization.

As an example, the lens integrated beamsteering antenna array 100 may include a plurality of antenna elements, wherein each antenna element comprises: a single-pole-double-throw (SPDT) switch; a metallic ground plane having a pair of apertures; an annulus of dielectric on the metallic ground plane; a conductive loop on the annulus of dielectric; a conductive loop; and a pair of vias configured to couple from the SPDT switch through the pair of apertures in the metallic ground plane to the conductive loop, wherein the SPDT switch is configured to select for either via in the pair of vias responsive to a polarization control signal and to drive a first RF signal into the selected one of the vias during a transmission mode of operation.

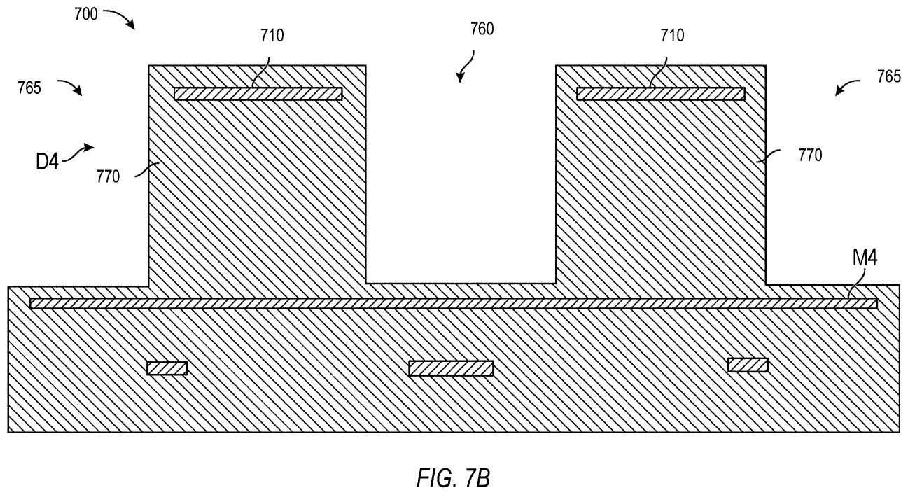

Turning now to the drawings, an antenna element 700 is shown in a cross-sectional view in FIG. 7A. antenna element 700 is constructed using a number of metal layers formed over a substrate such as a flexible substrate 715 (e.g., Kapton or RO4350). A first metal layer M1 forms a lead for a control signal that controls whether antenna 700 functions with RHCP or LHCP. A second metal layer M2 forms the feed network and thus includes a lead for the RF signal (either for transmitting or receiving). A third metal layer M3 includes leads for the RF signal and also for the control signal to be coupled to the polarization control switch discussed further below. A fourth metal layer M4 forms a universal ground plane for shielding antenna element 700 from the control signal and RF feeds in the lower metal layers. Finally, a fifth metal layer M5 forms the radiating element for antenna element 700, which is an open circular coil 710 but which may deviate from a circular shape in alternative embodiments. The outer diameter of the annulus formed by circular loop or coil 710 may be 2200μ (30% λ) whereas its inner diameter may be 1600μ (21.8% λ). The width of the metal lead forming circular loop 710 is thus 300μ (4% λ) whereas its thickness is 10μ. The other metal layers M1 through M4 may also be 10μ in thickness.

A single-pole double-throw (SPDT) switch 720 functions as the polarization control switch to control the selection of RHCP or LHCP for antenna element 700 responsive to the control signal. Should the control signal select for RHCP, SPDT switch 720 selects for a via 725 that extends between the M4 and M5 metal layers to drive with the RF signal (or to receive the RF signal). Conversely, SPDT switch 720 selects for a via 130 that also extends between the M4 and M5 metal layers if the control signal commands for LHCP operation. The spacing between vias 725 and 730 is configured so that the transmitted signal radiates away from antenna 705 as opposed to coupling back into the return via. For example, if the RF signal is driven into via 725, RF energy should not couple back through via 730 in any appreciable fashion. If vias 725 and 730 are too close, the coupling between the two vias would become too high. Conversely, the circular polarization (whether RHCP or LHCP) would degrade if vias 725 and 730 are spaced too far apart. For the Ka band, a spacing of 450μ (6% λ) results in advantageous polarization for antenna element 700 and decoupling between vias 725 and 730. It will be appreciated that this via spacing is not shown in scale in FIG. 7A for illustration clarity.

The dielectric between the various metal layers may comprise the same flexible dielectric. For example, a dielectric layer D1 insulates metal layers M1 and M2 from each other. To reduce the coupling between these metal layers, dielectric layer D1 may have a thickness of 440μ (6% λ). The spacing between metal layers M2 and M3 may be thinner such that a dielectric layer D2 that insulates metal layers M2 and M3 from each other may have a thickness of 150μ (2% λ). There is thus a separation of 600μ (8% λ) between metal layers M3 and M1 in such an embodiment. A via 735 couples from metal layer M1 to metal layer M3 to carry the control signal. Similarly, a via 740 couples from metal layer M2 to metal layer M3 to propagate the control Another via 745 couples from metal layer M2 to metal layer M3 to carry the RF signal for transmission to SPDT switch 720. Via 745 may have a width of 100μ (1.3% λ) to provide a sufficiently low impedance to the RE signal. A dielectric layer D3 having a thickness of 1.00μ (133% λ) separates metal layer M3 from metal layer M4 (the ground plane). A dielectric layer D4 having a thickness of 700μ (9.3%)) insulates metal layer M5 from metal layer M4. Vias 725 and 730 may each have a thickness of 300μ (4% λ). To assist the coupling to circular loop 710, vias 725 and 730 may each end in a cap that is wider than the 300μ thickness. Each cap 750 may be 100μ (1.3% λ) thick.

Antenna element 700 is shown to scale in the cross-sectional view of FIG. 7B. For illustration clarity, the various vias are not shown in FIG. 7B. In addition, metal layers M1 through M3 are shown as a single metal layer supporting the RE feed network and CP control lines for illustration clarity. Dielectric layer D4 forms an annulus that supports circular loop 710. There is thus a “donut hole” of air 760 in the dielectric annulus, extending from loop 710 down to a thin dielectric coating on metal layer 4 (the ground plane). Similarly, an outer annulus 765 of air having the same thickness insulates antenna 700 from other antennas. The resulting insulation with air is quite advantageous in reducing coupling of antenna element 700 to other antennas. Note that SPDT 120 may be modified to include a power amplifier and a phase shifter for beam steering applications. In an alternative embodiment, the phase shifter and power amplifier may be implemented in a separate integrated circuit coupled to the feed network on the M2 metal layer. Antenna array 705 may be advantageously implemented in a system such as described in U.S. Pat. Nos. 9,244,163 and 9,748,645, the contents of both of which are here incorporated by reference in their entirety.

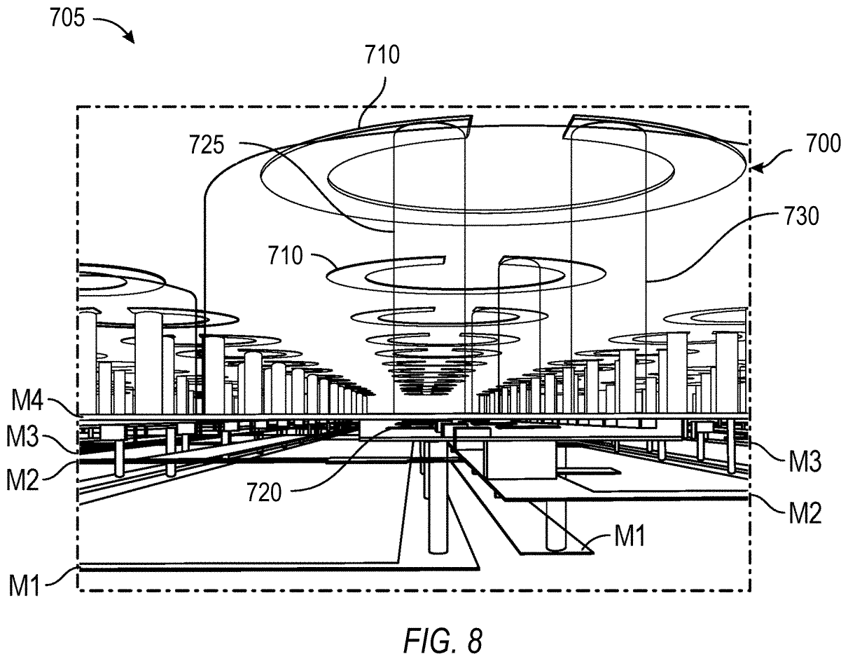

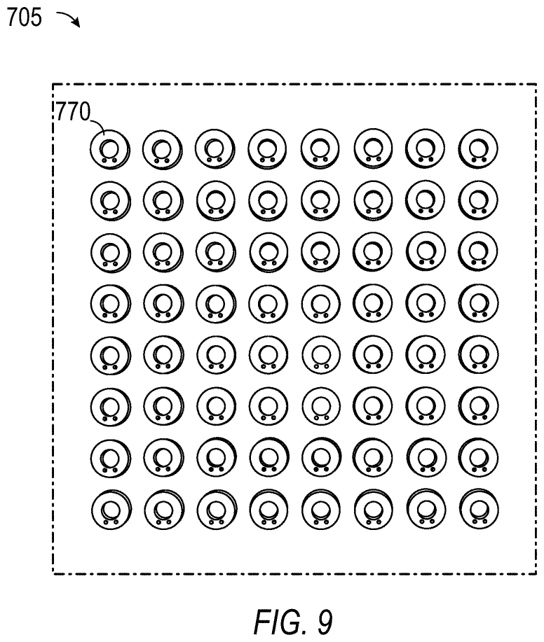

Antenna element 700 may be arranged into an array 705 of similar antennas as shown in the perspective view of FIG. 8. For illustrated on clarity, the dielectric layers D1 through D3 are not shown in FIG. 8, Array 705 is shown in plan view in FIG. 9. Each antenna element is supported by its own annulus of dielectric 770. It will be appreciated that the array size for array 705 may be any suitable size such as 4×4, 8×8, 32×32 or the illustrated size of 16×16.

It will be understood that various aspects or details of the disclosure may be changed without departing from the scope of the disclosure. It is not exhaustive and does not limit the claimed disclosures to the precise form disclosed. Furthermore, the foregoing description is for the purpose of illustration only, and not for the purpose of limitation. Modifications and variations are possible in light of the above description or may be acquired from practicing the disclosure. The claims and their equivalents define the scope of the disclosure. Moreover, although the techniques have been described in language specific to structural features and/or methodological acts, it is to be understood that the appended claims are not necessarily limited to the features or acts described. Rather, the features and acts are described as example implementations of such techniques.

It will also be understood that various aspects or details of the invention may be changed without departing from the scope of the invention. It is not exhaustive and does not limit the claimed inventions to the precise form disclosed. Furthermore, the foregoing description is for the purpose of illustration only, and not for the purpose of limitation. Modifications and variations are possible in light of the above description or may be acquired from practicing the invention. The claims and their equivalents define the scope of the invention.

The description of the different examples of implementations has been presented for purposes of illustration and description, and is not intended to be exhaustive or limited to the examples in the form disclosed. Many modifications and variations will be apparent to those of ordinary skill in the art. Further, different examples of implementations may provide different features as compared to other desirable examples. The example, or examples, selected are chosen and described in order to best explain the principles of the examples, the practical application, and to enable others of ordinary skill in the art to understand the disclosure for various examples with various modifications as are suited to the particular use contemplated.

I claim:

1. A lens integrated beamsteering antenna array with improved scan coverage, the lens integrated beamsteering antenna array comprising:
a dielectric lens having a front surface and a back surface; and
an antenna array embedded within the dielectric lens proximate to the back surface of the dielectric lens,
wherein
the antenna array is directed towards the front surface of the dielectric lens and is configured to transmit and receive through the dielectric lens and the front surface at a first frequency, and
the dielectric lens has a thickness that is configured to allow the antenna array to form an antenna beam within the dielectric lens at the first frequency.

2. The lens integrated beamsteering antenna array of claim 1, wherein the thickness is at least equal to a far-field distance from the antenna array.

3. The lens integrated beamsteering antenna array of claim 2, wherein
the antenna array has an antenna front surface directed towards the front surface of the dielectric lens and an antenna boresight, and
the dielectric lens has a dielectric material that causes an antenna beam produced by the antenna array to deflect away from the antenna boresight.

4. The lens integrated beamsteering antenna array of claim 3, wherein the antenna array is embedded within the dielectric lens by having the antenna front surface physically attached to the back surface of the dielectric lens.

5. The lens integrated beamsteering antenna array of claim 3, wherein the dielectric lens is a hemispherical dielectric lens and the thickness is a radial thickness from the antenna array to the front surface of the dielectric lens.

6. The lens integrated beamsteering antenna array of claim 3, wherein the dielectric material is polytetrafluoroethylene (PTFE) having a dielectric constant value of approximately 2.1.

7. The lens integrated beamsteering antenna array of claim 3, wherein the antenna array includes antenna elements that are configured to operate in either right-hand circular polarization or left-hand circular polarization.

8. The lens integrated beamsteering antenna array of claim 7, wherein each antenna element comprises:
a single-pole-double-throw (SPDT) switch;
a metallic ground plane having a pair of apertures;
an annulus of dielectric on the metallic ground plane;
a conductive loop on the annulus of dielectric;
a conductive loop; and
a pair of vias configured to couple from the SPDT switch through the pair of apertures in the metallic ground plane to the conductive loop, wherein the SPDT switch is configured to select for either via in the pair of vias responsive to a polarization control signal and to drive a first RF signal into the selected one of the vias during a transmission mode of operation.

9. The lens integrated beamsteering antenna array of claim 8, wherein each antenna element further comprises:
a substrate;
a first metal layer on the substrate, the first metal layer being patterned into a lead for the polarization control signal;
a second metal layer separated from the first metal layer by a first dielectric layer, the second metal layer being patterned into a lead for the first RF signal; and
a first dielectric layer separating the first metal layer from the second metal layer.

10. The lens integrated beamsteering antenna array of claim 9, wherein each antenna element further comprising:
a third metal layer patterned into leads coupled to the pair of vias;
a second dielectric layer separating the third metal layer from the second metal layer, wherein the SPDT switch is electrically coupled to the leads in the third metal layer; and
a third dielectric layer separating the third metal layer from the metallic ground plane.

11. A method for extending a scan coverage of an antenna array integrated within a dielectric lens having a front surface and back surface, wherein the dielectric lens is embedded within the dielectric lens proximate to the back surface, the method comprising:
producing an antenna beam, with the antenna array, within the dielectric lens that is directed towards a front surface of the dielectric lens; and
deflecting the antenna beam away from an antenna boresight of the antenna array when the antenna beam emerges from the dielectric lens at the front surface.

12. The method of claim 11, wherein
producing the antenna beam includes producing the antenna beam within the dielectric lens having a first scan angle within the dielectric lens, and
deflecting the antenna beam includes producing a second scan angle at the front surface of the dielectric that is greater than the first scan angle.

13. The method of claim 11, wherein producing the antenna beam includes producing the antenna beam with a far-field radiation pattern within the dielectric lens at a first distance that is shorter than a second distance from the antenna array to the front surface of the dielectric lens.

14. The method of claim 13, wherein producing the antenna beam further includes shaping the far-field radiation pattern within the dielectric lens with one or more dielectric materials of the dielectric lens.

15. The method of claim 14, wherein shaping the far-field radiation pattern includes increasing the directivity of the antenna beam and reducing side-lobes of the far-field radiation pattern within the dielectric lens.
